(19) United States
(12) Patent Application Publication
(10) Pub. No.: US 2002/0141070 A1
(43) Pub. Date: Oct. 3, 2002

(54) Color projection device

(75) Inventor: Yasumasa Sawai, Yamatotakada-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/085,650

(22) Filed: Feb. 27, 2002

(30) Foreign Application Priority Data
Mar. 27, 2001 (JP) 2001-90294

(51) Int. Cl. G02B 27/14

(52) U.S. Cl. 359/634

(57) ABSTRACT

A color projection device has a light source for emitting illumination light; a plurality of DMDs™, each of the DMDs™ modulating illumination light corresponding to color light, and emitting projection light; a dichroic prism for splitting illumination light into light of a plurality of colors, and emitting the separated color light to a corresponding the DMD™, and combining and emitting projection light from the DMDs™; an illumination optical system for directing illumination light from the light source to the dichroic prism; and a projection optical system for projecting the composite projection light on a screen. The color projection device fulfills the predetermined mathematical condition.

### RELATED APPLICATION

This application is based on Patent Application No. 2001-90294 filed in Japan, the content of which is hereby incorporated by reference.

### FIELD OF THE INVENTION

The present invention relates to a color projection device, and more specifically relates to a color projection device provided with a DMD (digital micromirror device™, manufactured by Texas Instruments Co.) as an optical modulator.

### DESCRIPTION OF THE RELATED ART

In recent years DMD™ has been noted as a mirror-deflection type modulator. The DMD™ has a display surface of a plurality of micromirrors arranged in a matrix, in which a single micromirror comprises one pixel of the display image. The inclination of each micromirror is individually controlled for optical modulation, and each micromirror has two inclination states comprising an ON state and an OFF state.

When the micromirror is in the ON state, illumination light is reflected within the projection optical system, and when the micromirror is in the OFF state, illumination light is reflected to outside the projection optical system. Accordingly, only light reflected by a micromirror in the ON state is directed onto the projection surface (e.g., projection screen) by the projection optical system, and as a result, a display image comprising a shaded pattern is formed on the projection surface.

FIG. 2 is an optical structural diagram of an example of a conventional color projection device provided with a DMD™. Part (a) in the drawing shows a dichroic prism viewed from the front, and part (b) is a side view showing the complete structure. In part (b) of the drawing, reference number 1 refers to a light source comprising a high voltage mercury lamp, which emits white light. Reference number 2 refers to a reflector arranged so as to surround the light source 1, and has a rotating elliptical surface as a reflecting surface 2a.

Behind the light source 1 (to the right in the drawing) a rod-shaped kaleidoscope 3 is arranged with the lengthwise direction along the optical axis X. The light source 1 is disposed at one focal position of the rotating elliptical surface, and light emitted from the light source 1 converges on the other focal point and enters one end of the kaleidoscope 3 through an entrance surface 3a. Light entering the kaleidoscope 3 is repeatedly reflected by interior surface reflection to attain uniform light distribution, then exits from an exit surface 3b at the other end of the kaleidoscope 3.

A condensing lens 4 is disposed directly behind the exit surface 3b of the kaleidoscope 3, and a relay optical system 5 is disposed directly therebehind. The lenses and the like of the relay optical system 5 are omitted from the drawing. Light exiting from the kaleidoscope 3 is efficiently directed to the relay optical system 5 by the condenser lens 4, and passes through an entrance lens 6 disposed at the entrance side of a TIR (total internal reflection) prism PR, and from the TIR prism PR passes through a dichroic prism DP, and uniformly illuminates the DMD™ with near telecentricity. From the kaleidoscope 3 to the entrance lens 6 is designated an illumination optical system IL.

The TIR prism PR comprises a first prism PR1 and a second prism PR2, each respectively having an approximate triangular pyramid shape, and an airgap layer is provided between the inclined surfaces of the prisms. The entrance light and the exit light of the DMD™ are separated by the TIR prism PR. The first prism PR1 totally reflects the illumination light exiting from the illumination optical system IL via a total reflection surface PR1a of the inclined surface. The incidence angle of the illumination light relative to the total reflection surface PR1a at this time is 47.5°. The total reflection surface PR1a opposes the inclined surface of the second prism PR2 through the airgap.

The illumination light F-number is 3, and has an angular distribution of approximate 9.5° unilateral in the air relative to the principal ray, and approximate 6.3° unilateral in the prism. On the other hand, since the refractive index of the TIR prism PR is n=1.52, the total reflection condition is such that the incidence angle is approximately 41.1° or greater relative to the interface with the air. For this reason the illumination light satisfies the total reflection condition, and is totally reflected by the total reflection surface PR1a. The illumination light then enters the dichroic prism DP, and is separated into the colors red, green, and blue.

The dichroic prism DP is disposed on the underside of the TIR prism PR; approximately triangular pyramid-shaped first prism DP1 and second prism DP2, and approximately quadrangular pyramid shaped third prism DP3 are combined in a downward facing sequence, as shown in part (a) of the drawing. Provided between the first prism DP1 and second prism DP2 are a dichroic surface B for reflecting blue light, and an airgap layer adjacent to the dichroic surface B. Furthermore, a dichroic surface R for reflecting red light is provided between the second prism DP2 and the third prism DP3.

Among the illumination light entering from the entrance/exit surface DPa of the top surface of the first prism DP1, i.e., the top surface of the dichroic prism DP, the blue light is reflected by the dichroic surface B, and the green light and red light are transmitted therethrough. The blue light reflected by the dichroic surface B is totally reflected by the entrance/exit surface DPa, and exits from the entrance/exit surface DP1a, i.e., the side surface of the first prism DP1, to illuminate blue DMD™.

Among the green light and red light transmitted through the dichroic surface B, the red light is reflected by the dichroic surface R, and the green light is transmitted therethrough. The red light reflected by the dichroic surface R is totally reflected by the airgap layer provided adjacent to the dichroic surface B, and exits from the entrance/exit surface DP2a, i.e., the side surface of the second prism DP2, to illuminate the red DMD™ 12. The green light transmitted through the dichroic surface R exits from the entrance/exit surface DP3a, i.e., the bottom surface of the third prism DP3, to illuminate the green DMD™ 13.

The deflection angle of each DMD™ is ±10°, the projection optical axis P shown in part (a) of the drawing becomes a normal line direction perpendicular to each DMD™ (the green DMD™ is shown in the example), and the illumination optical axis I is set at 20° to the normal line. Then, the illumination light of each color illuminates the corresponding DMD™ at an incidence angle of 20°.

The micromirror of each pixel of the DMD™ reflects illumination light at an inclination of 10° to the illumination light optical axis I side, such that the ON light exits as projection light in a direction perpendicular to the DMD™. The illumination light is reflected at an inclination of 10° in the opposite direction to the illumination light optical axis I side, such that the OFF light exits at an exit angle of 40°. Optical modulation is accomplished in this way.

The optical path of the projection light from each DMD™ is described below. The blue projection light reflected by the blue DMD™ enters the entrance/exit surface DP1a, and is totally reflected by the entrance/exit surface DPa of the dichroic prism DP, and thereafter is reflected by the dichroic surface B. The red projection light reflected by the red DMD™ enters the entrance/exit surface DP2a and is totally reflected by the airgap layer provided adjacent to the dichroic surface B, and thereafter is reflected by the dichroic surface R and is transmitted through the dichroic surface B. The green projection light reflected by the green DMD™ enters the entrance/exit surface DP3a, and is transmitted through the dichroic surface R and dichroic surface B.

The projection light of each blue, red, and green color are combined on the same optical axis, and exit from the entrance/exit surface DPa of the dichroic prism DP, and enter the TIR prism PR. Then, the composite projection light enters the airgap layer of the TIR prism PR at an incidence angle of 34.5°. At this time, the projection light F-number is 3 and identical to the F-number of the illumination light, and the projection light has an angular distribution of approximate 9.5° unilateral in the air relative to the principal ray, and approximate 6.3° unilateral in the prism, however, because the total reflection condition is not satisfied, the projection light is transmitted through the airgap layer, and projected onto a screen not shown in the drawing by a projection optical system PL comprising a plurality of lenses and the like. The lenses of the projection optical system PL are omitted from the drawing.

In the above-described conventional structure, however, differences arise in dichroic characteristics which reduce light-use efficiency due to the different entrance angles of the illumination light and projection light to the dichroic surfaces. That is, the projection optical axis P and the respective normal lines of the two dichroic surfaces R and B in the dichroic prism DP are in the same plane perpendicular to a plane including the projection optical axis P and the illumination optical axis I, and the dichroic surfaces R and B within this plane are arranged such that the respective normal lines have inclinations of 11.3° and 28.5°, respectively, relative to the projection optical axis P in mutually opposite directions.

For this reason, when the refractive index of the dichroic prism DP is n=1.52, the entrance angles to the dichroic surfaces R and B are 17.4° and 31.2° for the illumination light, and 11.3° and 28.5° for the projection light, which are different. The illumination optical axis I is the optical axis before the illumination light is split into each color, and the projection optical axis P is the optical axis after the projection light of each color has been combined one with another. In other words, each optical axis of the illumination light and projection light relative to the green DMD™ is as shown in part (b) of the drawing.

In the conventional structure, the relationship of the illumination optical axis, projection optical axis, and dichroic surfaces is generally defined by the equation below.

a=90°+θ

Where a represents the angle formed by the center line of the illumination optical axis and projection optical axis, and the line of intersection of the dichroic surface of the dichroic prism and a plane including the illumination optical axis and projection optical axis, and the angle formed by the illumination optical axis and the projection optical axis is 2θ. In the drawing, the center line is indicated by the symbol C.

FIG. 3 is a graph showing dichroic characteristics. In the drawing, the horizontal axis shows the wavelength (nm), and the vertical axis shows the transmittance. Also in the drawing, the curve “a” drawn by the single-dash line represents the characteristics when the projection light enters the dichroic surface B at an incidence angle of 28.5°, and curve “b” drawn by the two-dash line represents the characteristics when the illumination light enters the dichroic surface B at an incidence angle of 31.2°. Curve “c” drawn by the solid line represents the characteristics when the projection light enters the dichroic surface R at an incidence angle of 11.3°, and curve “d” drawn by the broken line represents the characteristics when the illumination light enters the dichroic surface R at an incidence angle of 17.4°.

Reading the drawing, among the characteristics of each dichroic surface, the cutoff wavelengths of the illumination light and projection light, i.e., the 50% transmittance (0.5) wavelengths, are different. Specifically, in the dichroic surface B, the cutoff wavelength is 499 nm in the characteristics represented by the curve “a”, and 490 nm in the characteristics represented by the curve “b”. In the dichroic surface R, the cutoff wavelength is 593 nm in the characteristics represented by the curve “c”, and 580 nm in the characteristics represented by the curve “d”. For this reason, the light in the wavelength range between curves “a” and “b”, and curves “c” and “d” cannot be used to project an image, thereby lowering light-use efficiency.

In the above-described conventional structure, the OFF light, i.e., the non-display light from the DMD™, easily increases local density because most of this light flux is combined by the dichroic prism DP and concentrated at the entrance/exit surface DPa. Accordingly, heat countermeasures by processing this OFF light has become an issue.

That is, when the exit angle from the DMD™ of the non-display OFF light is 40° and the refractive index of the dichroic prism DP is n=1.52, the OFF light has an angular distribution of approximately ±6.3° and enters the dichroic surfaces R and B at incidence angle of 29.4° and 38.7°, respectively.

Since the total reflection condition is that the incidence angle relative to the interface with the air is approximately 41.1° or greater, in this case most of the OFF light is not completely reflected even when an airgap layer is provided on the dichroic surface, but rather is transmitted and the light of each color is combined by the dichroic prism DP, and concentrated at the entrance/exit surface DPa. Accordingly, an increase in local density readily occurs.

### OBJECTS AND SUMMARY

In view of these problems, an object of the present invention is to provide a color projection device having a structure which increases light-use efficiency, and prevents local temperature elevation by alleviating the concentration of OFF light from the DMD™.

The present invention attains these objects by providing a structure wherein light from a light source is directed by an illumination optical system to a dichroic prism, split into separate light of a plurality of colors by this dichroic prism, and thereafter the light of each color is modulated by being reflected by a corresponding DMD™, and after the modulated light of each color is combined by the dichroic prism, the light is projected by a projection optical system; and wherein the condition equation below is satisfied.

90°≦a<90°+θ

Where a represents the angle formed by the center line of the illumination optical axis and projection optical axis, and the line of intersection of the dichroic surface of the dichroic prism and a plane including the illumination optical axis and projection optical axis, and the angle formed by the illumination optical axis and the projection optical axis is 2θ.

Furthermore, an airgap layer is provided adjacent to the dichroic surface.

### BRIEF DESCRIPTION OF THE DRAWINGS

This and other objects and features of this invention will become clear from the following description taken in conjunction with the preferred embodiments with reference to the accompanying drawings, in which:

FIG. 1 is an optical structure diagram showing an embodiment of the color projection device of the present invention;

FIG. 2 is an optical structure diagram showing an example of a conventional color projection device; and

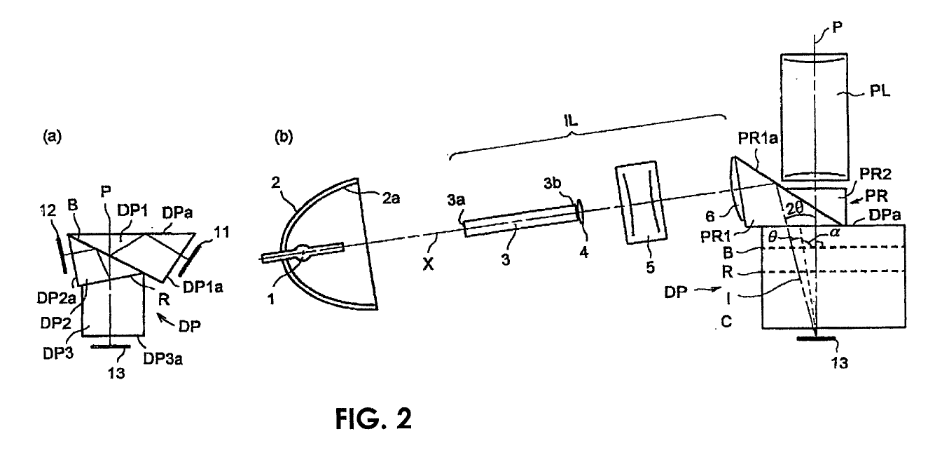

FIG. 3 is a graph showing dichroic characteristics.

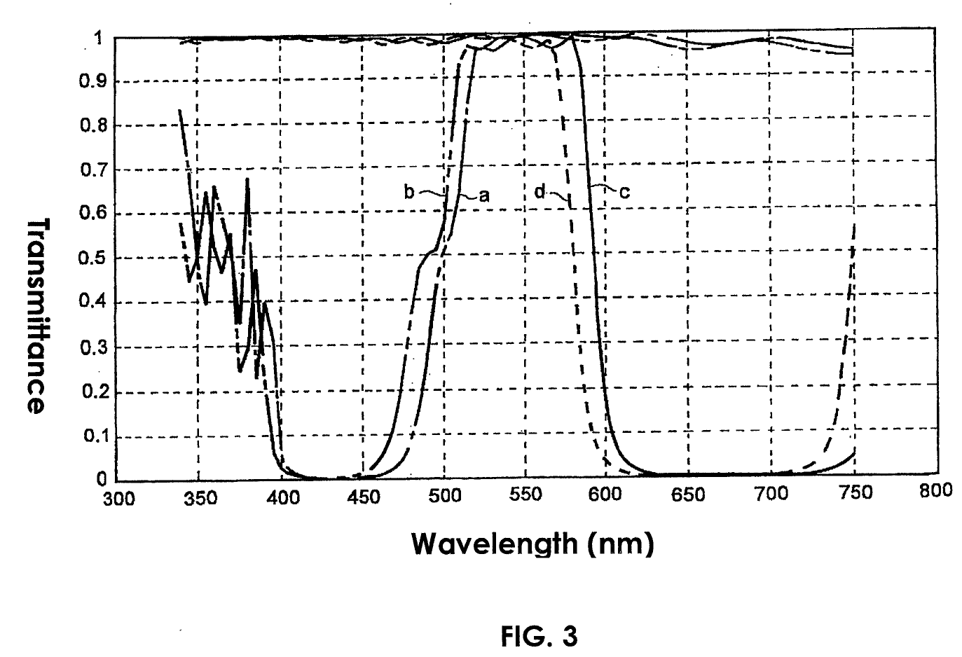

### DESCRIPTION OF THE PREFERRED EMBODIMENTS

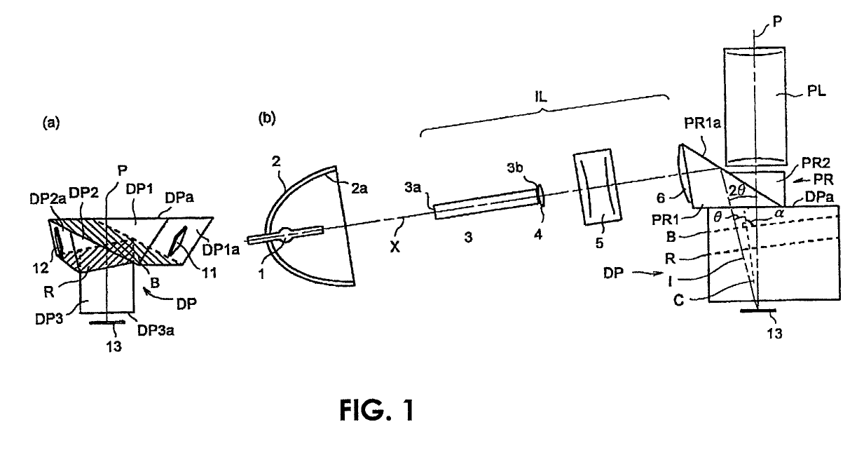

The embodiments of the present invention are described hereinafter with reference to the drawings. FIG. 1 is an optical structure view showing an embodiment of a color projection device of the present invention. Part (a) of the drawing shows the dichroic prism viewed from the front, and part (b) of the drawing is a side view of the entire structure. Parts having similar operation in this drawing and the conventional example are designated by like reference numbers.

In part (b) of the drawing, reference number 1 refers to a light source comprising a high voltage mercury lamp, which emits white light. Reference number 2 refers to a reflector arranged so as to surround the light source 1, and has a rotating elliptical surface as a reflecting surface 2a. Behind the light source 1 (to the right in the drawing) a rod-shaped kaleidoscope 3 is arranged with the lengthwise direction along the optical axis X. The light source 1 is disposed at one focal position of the rotating elliptical surface, and light emitted from the light source 1 converges on the other focal point and enters one end of the kaleidoscope 3 through an entrance surface 3a. Light entering the kaleidoscope 3 is repeatedly reflected by interior surface reflection to attain uniform light distribution, then exits from an exit surface 3b at the other end of the kaleidoscope 3.

A condensing lens 4 is disposed directly behind the exit surface 3b of the kaleidoscope 3, and a relay optical system 5 is disposed directly therebehind. The lenses and the like of the relay optical system 5 are omitted from the drawing. Light exiting from the kaleidoscope 3 is efficiently directed to the relay optical system 5 by the condenser lens 4, and passes through an entrance lens 6 disposed at the entrance side of a TIR prism PR, and from the TIR prism PR passes through a dichroic prism DP, and uniformly illuminates the DMD™ with near telecentricity. From the kaleidoscope 3 to the entrance lens 6 is designated an illumination optical system IL.

The TIR prism PR comprises a first prism PR1 and a second prism PR2, each respectively having an approximate triangular pyramid shape, and an airgap layer is provided between the inclined surfaces of the prisms. The entrance light and the exit light of the DMD™ are separated by the TIR prism PR. The first prism PR1 totally reflects the illumination light exiting from the illumination optical system IL via a total reflection surface PR1a of the inclined surface. The incidence angle of the illumination light relative to the total reflection surface PR1a at this time is 47.5°. The total reflection surface PR1a opposes the inclined surface of the second prism PR2 through the airgap.

The illumination light F-number is 3, and has an angular distribution of approximate 9.5° unilateral in the air relative to the principal ray, and approximate 6.3° unilateral in the prism. On the other hand, since the refractive index of the TIR prism PR is n=1.52, the total reflection condition is such that the incidence angle is approximately 41.1° or greater relative to the interface with the air. For this reason the illumination light satisfies the total reflection condition, and is totally reflected by the total reflection surface PR1a. The illumination light then enters the dichroic prism DP, and is separated into the colors red, green, and blue.

The dichroic prism DP is disposed on the underside of the TIR prism PR; approximately triangular pyramid-shaped first prism DP1 and second prism DP2, and block-shaped third prism DP3 are combined in a downward facing sequence, as shown in part (a) of the drawing. Provided between the first prism DP1 and second prism DP2 are a dichroic surface B for reflecting blue light, and an airgap layer adjacent to the dichroic surface B. Furthermore, a dichroic surface R for reflecting red light is provided between the second prism DP2 and the third prism DP3, and an airgap layer is provided adjacent to the dichroic surface R.

Among the illumination light entering from the entrance/exit surface DPa of the top surface of the first prism DP1, i.e., the top surface of the dichroic prism DP, the blue light is reflected by the dichroic surface B, and the green light and red light are transmitted therethrough. The blue light reflected by the dichroic surface B is totally reflected by the entrance/exit surface DPa, and exits from the entrance/exit surface DP1a, i.e., the side surface of the first prism DP1, to illuminate blue DMD™.

Among the green light and red light transmitted through the dichroic surface B, the red light is reflected by the dichroic surface R, and the green light is transmitted therethrough. The red light reflected by the dichroic surface R is totally reflected by the airgap layer provided adjacent to the dichroic surface B, and exits from the entrance/exit surface DP2a, i.e., the side surface of the second prism DP2, to illuminate the red DMD™ 12. The green light transmitted through the dichroic surface R exits from the entrance/exit surface DP3a, i.e., the bottom surface of the third prism DP3, to illuminate the green DMD™ 13.

The deflection angle of each DMD™ is ±10°, the projection optical axis P shown in part (a) of the drawing becomes a normal line direction perpendicular to each DMD™ (the green DMD™ is shown in the example), and the illumination optical axis I is set at 20° to the normal line. Then, the illumination light of each color illuminates the corresponding DMD™ at an incidence angle of 20°.

The micromirror of each pixel of the DMD™ reflects illumination light at an inclination of 10° to the illumination light optical axis I side, such that the ON light exits as projection light in a direction perpendicular to the DMD™. The illumination light is reflected at an inclination of 10° in the opposite direction to the illumination light optical axis I side, such that the OFF light exits at an exit angle of 40°. Optical modulation is accomplished in this way.

The optical path of the projection light from each DMD™ is described below. The blue projection light reflected by the blue DMD™ 11 enters the entrance/exit surface DP1a, and is totally reflected by the entrance/exit surface DPa of the dichroic prism DP, and thereafter is reflected by the dichroic surface B. The red projection light reflected by the red DMD™ 12 enters the entrance/exit surface DP2a and is totally reflected by the airgap layer provided adjacent to the dichroic surface B, and thereafter is reflected by the dichroic surface R and is transmitted through the dichroic surface B. The green projection light reflected by the green DMD™ 13 enters the entrance/exit surface DP3a, and is transmitted through the dichroic surface R and dichroic surface B.

The projection light of each blue, red, green color are combined on the same optical axis, and exit from the entrance/exit surface DPa of the dichroic prism DP, and enter the TIR prism PR. Then, the composite projection light enters the airgap layer of the TIR prism PR at an incidence angle of 34.5°. At this time, the projection light F-number is 3 and identical to the F-number of the illumination light, and the projection light has an angular distribution of approximate 9.5° unilateral in the air relative to the principal ray, and approximate 6.3° unilateral in the prism, however, because the total reflection condition is not satisfied, the projection light is transmitted through the airgap layer, and projected onto a screen not shown in the drawing by a projection optical system PL comprising a plurality of lenses and the like. The lenses of the projection optical system PL are omitted from the drawing.

The respective normal lines of the two dichroic surfaces R and B in the dichroic prism DP are lines inclined 11.3° and 28.5° relative to the projection optical axis P in mutually opposite directions within a plane including the projection optical axis P perpendicular to a plane including the illumination optical axis I and the projection optical axis P, and are inclined 6.6° to the illumination optical axis I side using a line perpendicular to the plane including the illumination optical axis I and the projection optical axis P as the rotational axis. The 6.6° is equivalent to 10° in air.

As previously mentioned, a=90° represents the angle formed by the center line of the illumination optical axis and projection optical axis, and the line of intersection of the dichroic surface of the dichroic prism and a plane including the illumination optical axis and projection optical axis, and when the refractive index of the dichroic prism DP is n=1.52, the incidence angle to the dichroic surface B becomes 29.2° for both illumination light and projection light, the incidence angle to the dichroic surface R becomes 13.1° for both illumination light and projection light, and the characteristics of both illumination light and projection light are identical at the dichroic surface. In this way, the characteristics of the illumination light and projection light at the dichroic surface can be equalized by inclining the dichroic surface to the illumination axis side, thereby providing a projection device of excellent light-use efficiency.

In the above structure, the relationship of the illumination optical axis, projection optical axis, and dichroic surfaces is generally defined by the condition equation below (1)

90°≦a<90°+θ (1)

Where a represents the angle formed by the center line of the illumination optical axis and projection optical axis, and the line of intersection of the dichroic surface of the dichroic prism and a plane including the illumination optical axis and projection optical axis, and the angle formed by the illumination optical axis and the projection optical axis is 2θ. In the drawing, the center line is indicated by the symbol C.

In this way, the difference in the incidence angles of the illumination light and projection light to the dichroic surface is reduced. It is desirable that the difference in the incidence angles of the illumination light and projection light to the dichroic surface is eliminated by setting a=90° as in the present embodiment. Although the inclinations of the dichroic surfaces R and B to the illumination optical axis side are set at identical angles in the present embodiment, these inclination may differ within the range prescribed by condition equation (1).

On the other hand, since the exit angle of the OFF light, i.e., non-display light, from the DMD™ is 40°, the green OFF light enters the dichroic surface R at an incidence angle of 35.6° while maintaining an angular distribution of approximately ±6.3°. Since an airgap layer is also provided on the dichroic surface R in the present embodiment, light flux arriving at the entrance/exit surface DPa of the dichroic prism DP is reduced because part of the green OFF light is totally reflected. The totally reflected part of this light is separated from OFF light of other colors. If the inclination of the dichroic surface R is increased to the illumination optical axis side, the percentage of totally reflected light increases, and the percentage separated from OFF light of other colors increases.

Furthermore, since the green OFF light transmitted through the airgap of the dichroic surface R enters the dichroic surface B at a incidence angle of 43.3° while maintaining an angular distribution of approximately ±6.3°, the light flux arriving at the entrance/exit surface DPa of the dichroic prism DP is reduced because the much of this light is totally reflected.

The red OFF light is totally reflected by the airgap layer of the dichroic surface B, reflected by the dichroic surface R, and thereafter again enters the dichroic surface B at an incidence angle of 43.3° while maintaining an angular distribution of approximately ±6.3° identical to the green OFF light. The light flux arriving at the entrance/exit surface DPa of the dichroic prism DP is reduced because the much of this light is totally reflected.

The blue OFF light is totally reflected by the entrance/exit surface DPa of the dichroic prism DP, reflected by the dichroic surface B, and thereafter again enters the entrance/exit surface DPa at an incidence angle of approximately 27.4° and is transmitted therethrough. For this reason, the blue OFF light is separated from other color OFF light.

By inclining each dichroic surface to the illumination optical axis side and providing an airgap layer adjacent to each dichroic surface, OFF light is totally reflected by the airgap layers and the OFF light is not concentrated, such that local temperature elevation is easily prevented, and a projection device is obtained which easily manages heat countermeasures.

As described above, the present invention provides a color projection device having a structure which increases light-use efficiency, and prevents local temperature elevation by alleviating the concentration of OFF light from the DMD™.

Specifically, a bright projection device having improved light-use efficiency is obtained which reduces or eliminates the difference in dichroic characteristics between the illumination light and projection light by satisfying the previously described condition equation (1).

Furthermore, total reflection of OFF light is easily accomplished by an airgap layer by providing an airgap layer adjacent to the dichroic surfaces, and since the OFF light does not become concentrated, local temperature elevation is easily prevented and the heat countermeasures readily achieved. Therefore, product quality and reliability are improved.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A color projection device comprising:
a light source for emitting illumination light;
a plurality of DMDs™, each of the DMDs™ modulating illumination light corresponding to color light, and emitting projection light;
a dichroic prism for splitting illumination light into light of a plurality of colors, and emitting the separated color light to a corresponding the DMD™, and combining and emitting projection light from the DMDs™; and
an illumination optical system for directing illumination light from the light source to the dichroic prism; and
a projection optical system for projecting the composite projection light on a screen;
wherein the condition below is satisfied:
90°≦a<90°+θ
where a represents the angle formed by the center line of the illumination optical axis and projection optical axis, and the line of intersection of the dichroic surface of the dichroic prism and a plane including the illumination optical axis and projection optical axis, and the angle formed by the illumination optical axis and the projection optical axis is 2θ.

2. A color projection device claimed in claim 1, wherein an airgap layer is provided adjacent to the dichroic surface of a dichroic mirror.

3. A color projection device claimed in claim 1, wherein a=90°.

4. A color projection device claimed in claim 1, wherein a TIR is included in the illumination optical system.

5. A dichroic prism for use in projection optical device, the dichroic prism splitting incident light into light of a plurality of colors, and emitting the separated color light, and combining and emitting light; wherein the condition below is satisfied:
90°≦a<90°+θ
where a represents the angle formed by the center line of an optical axis of incident light and an optical axis of emitting light, and the line of intersection of the dichroic surface of the dichroic prism and a plane including the optical axis of incident light and the optical axis of emitting light, and the angle formed by the optical axis of incident light and the optical axis of emitting light is 2θ.

6. A dichroic prism claimed in claim 1, wherein a=90°.
